(19) United States
(12) Patent Application Publication
(10) Pub. No.: US 2014/0279392 A1
(43) Pub. Date: Sep. 18, 2014

(54) Systems and Methods for Credit Enhancement for Trade Credit Transactions

(71) Applicant: NOWaccount Network Corporation, (US)

(72) Inventors: John Benjamin Hayes, Atlanta, GA (US); Lara O'Connor Hodgson, Atlanta, GA (US); Stacey Yvonne Abrams, Atlanta, GA (US)

(73) Assignee: NOWACCOUNT NETWORK CORPORATION, Atlanta, GA (US)

(21) Appl. No.: 13/843,498

(22) Filed: Mar. 15, 2013

(51) Int. Cl. G06Q 40/02; G06Q 40/08

(52) U.S. Cl. CPC G06Q 40/025; G06Q 40/08
USPC 705/38; 705/4

(57) ABSTRACT

Embodiments of the disclosure can include systems and methods for credit enhancement for trade credit transactions. In one embodiment, a method of reducing risk in trade credit transactions can be provided. The method can include receiving an offer to sell a trade receivable from a business; obtaining a credit rating for the business; instructing a sellers cooperative to pay a first portion of a purchase price to the seller, the sellers cooperative comprising small businesses that purchase trade receivables; and instructing a lender to release a second portion of the purchase price held in escrow to the seller after a period of time has passed.

### BACKGROUND

There is significant risk in trade credit transactions originated in small businesses. Trade credit is the credit granted by sellers to business and government buyers of good and services. A trade credit is created when a business sells goods or services to another business or government and extends credit to them. The Seller may then sell that receivable to a purchaser of trade credit. There are several types of risk associated with such a transaction. First, there is a risk as to whether the business owning the debt will pay on the receivable sold as a trade credit. For example, the business may go bankrupt or go out of business. Another risk is a dispute between the seller of goods or services and its customer, the buyer. There may be a dispute where the buyer is refusing to pay because he did not receive the goods, he is dissatisfied with the service provided to him, or he is dissatisfied with the service rendered. Such disputes cause the trade receivable to be less collectible.

Fraud is another significant risk. This type of risk arises when the business selling its receivable has committed fraud in the underlying transaction, and there really is no receivable because goods or services were not sold. In these instances, the receivable is not collectible. Lenders using trade receivables as collateral inherit these risks. Such risks are magnified because it is not simply an employee of the seller who may committing fraud but may actually be the owner or people running the business who commit fraud by submitting fictitious invoices.

The same problem exists in a true factoring situation (such as the credit card system) that exists when that trade receivable is used as collateral by a lender. In such a case, that receivable, if the goods or services are sold to a business or government, is a trade receivable rather than a consumer receivable. Typically, a credit card receivable is sold to the issuing bank through the merchant service system used in the credit card industry.

The risk in these transactions remains a significant problem in the trade credit marketplace, and there is a need for a solution to manage this exposure to risk.

### SUMMARY OF THE DISCLOSURE

Some or all of the above needs can be addressed by certain embodiments of the disclosure. According to embodiments of the disclosure, disclosed are systems and methods for credit enhancement for trade credit transactions. In one embodiment, a method for reducing risk in trade credit transactions can be provided. The method can include receiving an offer to sell a trade receivable from a business. The method can also include obtaining a credit rating for the selling business. The method can include instructing a sellers cooperative to pay a first portion of a purchase price to the seller, the sellers cooperative comprising small businesses that purchase trade receivables, which are managed by a servicer of trade receivables. Moreover, the method can include instructing the cooperative or a lender to release to a seller a second portion of the purchase price held in escrow after a period of time has passed.

In another embodiment, a system for reducing risk in trade credit transactions can be provided. The system can include at least one processor, and at least one memory for storing computer-readable instructions. The processor can be operable to access or execute the computer-readable instructions. The computer-readable instructions can be configured to: receive an offer to sell a trade receivable from a business, obtain a credit rating for the selling business, obtain a credit rating for the buyer, instruct a sellers cooperative to pay a first portion of a purchase price to the seller, wherein the sellers cooperative comprising small businesses that purchase trade receivables, and instruct a lender to release a second portion of the purchase price held in escrow to the seller after a period of time has passed.

In another embodiment, another method of reducing risk in trade credit transactions can be provided. The method can include receiving an offer to sell a trade receivable from a business. The method can also include obtaining a credit rating for the business. Furthermore, the method can include admitting a business to a sellers cooperative, the sellers cooperative comprising a plurality of companies selling trade receivables to the cooperative. Moreover, the method can include facilitating a purchase of a guarantee on the business, the guarantee paying a benefit if the business fails during a period of time after the sale of the trade receivable. The method can also include instructing a sellers cooperative to pay a first portion of a purchase price for the trade receivable to the business upon purchasing the trade receivable. Further, the method can include paying a second portion of the purchase price to the business after a period of time has passed.

In another embodiment, another system for reducing risk in trade credit transactions can be provided. The system can include at least one processor, and at least one memory for storing computer-readable instructions. The processor can be operable to access or execute the computer-readable instructions. The computer-readable instructions can be configured to: receive an offer to sell a trade receivable from a business, obtain a credit rating for the selling business, admit a business to a sellers cooperative, wherein the sellers cooperative comprising a plurality of companies selling trade receivables to the cooperative, facilitate a purchase of a guarantee on the business, wherein the guarantee pays a benefit if the business fails during a period of time after the sale of the trade receivable, instructing a sellers cooperative to pay a first portion of a purchase price for the trade receivable to the business upon purchasing the trade receivable, and paying a second portion of the purchase price to the business after a period of time has passed.

In yet another embodiment, another method of reducing risk in trade credit transactions can be provided. The method can include receiving an offer to sell a trade receivable from a business. The method can include obtaining credit rating for the selling business. The method can also include paying a first portion of a purchase price to the business upon purchasing the trade receivable. Furthermore, the method can include assigning the purchased trade receivable to a cooperative of sellers, the cooperative of sellers holding assets including assigned trade receivables. Moreover, the method can include issuing equity in the cooperative of sellers to the business.

In another embodiment, another system for reducing risk in trade credit transactions can be provided. The system can include at least one processor, and at least one memory for storing computer-readable instructions. The processor can be operable to access or execute the computer-readable instructions. The computer-readable instructions can be configured to: receive an offer to sell a trade receivable from a business, obtain credit rating for the business, paying a first portion of a purchase price to the business upon purchasing the trade receivable, assign the purchased trade receivable to a cooperative of sellers, wherein the cooperative of sellers holding assets including assigned trade receivables, and issue equity in the cooperative of sellers to the business.

### BRIEF DESCRIPTION OF THE FIGURES

Reference will now be made to the accompanying tables and drawings, which are not necessarily drawn to scale, and wherein:

FIG. 1 illustrates a block diagram of an example system according to at least one embodiment of the disclosure.

FIGS. 2A and 2B illustrate a flow diagram of an example process according to at least one embodiment of the disclosure.

FIG. 3 illustrates a flow diagram of an example process according to at least one embodiment of the disclosure.

FIG. 4 illustrates a flow diagram of another example process according to at least one embodiment of the disclosure.

FIG. 5 illustrates a flow diagram of an example process according to at least one embodiment of the disclosure.

FIG. 6 illustrates a block diagram of an exemplary computer system implementing the processes of the disclosure.

FIG. 7 illustrates a block diagram of components used in computer systems implementing the processes of the disclosure.

### DETAILED DESCRIPTION

Embodiments of the disclosure now will be described more fully hereinafter with reference to the accompanying drawings, in which certain embodiments are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Certain embodiments of the disclosure can provide systems and methods for credit enhancement for trade credit transactions. In one embodiment,

FIG. 1 illustrates a block diagram of an example system according to at least one embodiment of the disclosure. Servicer 100 can be an entity that interacts with small businesses to buy trade credit receivables from small businesses. Small businesses 102 can be sellers of goods and services who have trade credit receivables to sell. Sellers cooperative 104 can be a group of small businesses who have purchased trade credits from small businesses 102 directly or through servicer 100. Lead lender 106 can be a lender who funds sellers cooperative 104. Cooperative reserves 104 can be a pool of capital used by sellers cooperative 104. Senior lenders 110 and junior lenders 112 can be lenders who fund the lead lender 106 and the cooperative reserves 108. Partners 114 can be entities who source small businesses for servicer 100. B2B customers 116 are customers of small businesses 102 who owe payment for goods or services purchased from small businesses 102. Insurers 118 are entities who insure the payments owed by the buyers 116. Guarantors 120 are entities that sell guarantees that sellers 102 remain in business. In certain embodiments, guarantors 120 may be government entities.

Example Overall Methodology

FIGS. 2A and 2B illustrate a flow chart of showing interactions 200 between entities depicted in FIG. 1. According to various embodiments of the disclosure, these interactions may be implemented on computers interacting over a public communication network such as the Internet or public telephone network. At block 202, small business 102 may apply to servicer 100 to sell a trade receivable, and servicer 100 may underwrite the seller and obtain a credit rating, for example a Small Business Financial Exchange score on small business 102. Optionally, servicer 100 may confirm that small business 102 has any adverse filings made against it by a government or other entity. At block 204, assuming that the SBFE score is sufficient, small business 102 may sell the trade receivable to servicer 100 and be granted membership in sellers cooperative 104, and receive equity in the sellers cooperative until a final payment is made on the trade receivable sold to servicer 100. At block 206, the sellers cooperative 104 may purchase the trade receivable directly from the small business 102 or servicer 100 may purchase the trade receivable from the small business 102 and assign the purchased trade receivable to sellers cooperative 104. At block 208, a borrowing base certificate (referred to herein as “BBC”), a form prepared by a borrower that reflects the current status of the collateral, may be presented to lead lender 106. At block 210, senior lenders 110 and/or junior lenders 112 may fund cooperative reserves 108. At block 212, lead lender 106 may fund sellers cooperative 104. At block 214, senior lenders 110 and/or junior lenders 112 may fund sellers cooperative 104 through the lead lender 106. At block 216, a percentage of the value of receivables purchased from small businesses 102 may be paid by sellers cooperative 104, with the remaining value of the purchased invoices retained at block 218 by sellers cooperative 104 for a period of time, as what is referred to herein as a hold back. At block 220, a portion of the holdback may be paid to servicer 100. At block 224, after a period of time passes, for example 30 days, the remaining portion of the holdback may paid by seller's cooperative to small business 102 from an escrow account maintained at lead lender 106. At block 226, sellers cooperative 104 may pay servicer 100 for services. At block 226, servicer 100 may pay partners 114, for example distribution partners who source small businesses to servicer 100. At block 226, payment on the receivables held by sellers cooperative 104 may be made to sellers cooperative 104. This payment may come from a variety of obligors, such as the original obligor B2B customers 116, or buyers insurer 118 in the case that the buyer fails to pay, or seller's guarantor 120 in the event that the selling small business goes out of business.

Directing attention to FIG. 3, there is shown generally a method 300 practiced by servicer 100. At block 302, servicer 100 may receive an offer to sell a trade receivable from small business 102. At block 304, servicer 100 obtains a credit rating on small business 102 offering to sell the trade receivable from a credit rating source such as SBFE 105. At block 306, servicer 100 may instruct sellers cooperative 104 to issue a partial payment for the trade receivable to the small business 102 selling the trade receivable. At block 308, after a period of time passes, for example 30 days, servicer 100 may instruct lead lender 106 to release a second payment on the sale of the trade receivable to the small business 102 selling the trade receivable which lead lender 106 holds in escrow on behalf of small business 102 and sellers cooperative 104.

The purpose of holding back the second payment on the purchased receivable from small business 102 and to place it in escrow is to protect sellers cooperative 104 from changes in the cost of funds borrowed from lead lender 104, senior lenders 110 and junior lenders 112, or losses from failure to pay on invoices. Such losses are not on a transaction-by-transaction basis, but on overall performance of all obligors making payment to sellers cooperative 104. For example, in the event that B2B customer 116 fails to pay on the trade receivable, and insurer 118 might only pay a portion of the owed payment on behalf of B2B customer 116, and the unpaid amount is considered a loss and a portion of this loss is deducted from the escrow of the cumulative holdback amounts.

Directing attention to FIG. 4, an alternative method 400 practiced by servicer 100 is shown. At block 402, servicer 100 may receive an offer to sell a trade receivable from small business 102. At block 404, servicer 100 may obtain a credit rating on small business 102, for example from SBFE 105. At block 406, servicer 100 may purchase a guarantee on small business 102 that pays sellers cooperative 104 in the event that small business 102 goes out of business and payments from the original obligor, such as B2B customers 116 are not collected. At block 408, servicer 100 may instruct sellers cooperative 104 to pay a first portion of the value of the trade receivable sold to servicer 100. At block 410, after a period of time passes from the first payment made to small business 102, an amount held in escrow by lead lender 106 may be released to small business 102 as the remaining payment on the purchase of the trade receivable.

Again, as described above, the purpose of the holdback is to protect sellers cooperative 104 from a change in the cost of funds borrowed from lead lender 106, senior lenders 110 or junior lenders 112, or from losses incurred by sellers cooperative 104 due to lack of payment on the sold trade receivable by the original obligor, such as B2B customers 116, or due to partial payment made by insurer 118 or guarantor 120.

Directing attention to FIG. 5, another method 500 practiced by servicer 100 is shown. At block 502, servicer 100 may receive an offer to sell a trade receivable from small business 102. At block 504, servicer 100 may obtain a credit rating on small business 102 from a source of credit ratings, such as SBFE 105. At block 506, servicer 100 may instruct sellers cooperative 104 to pay a first portion of the sale price to small business 102. At block 508, servicer 100 may assign the purchased trade receivable to sellers cooperative 104. At block 510, after funds are placed in escrow with lead lender 106 and a period of time passes from the first payment made to small business 102, servicer 100 may instruct lead lender 106 to release a second payment for the purchased trade receivable to small business 102.

Example System Architecture

FIG. 6 illustrates a block diagram of an example system 600 that may be utilized in accordance with various embodiments of the disclosure to facilitate the system and methods described and illustrated above. As shown in FIG. 6, the system 600 may include one or more computers 602(A)-(N) controlled by servicer 100 and client devices 604. In certain embodiments, communications between the computers 602(A)-N and the client devices 604 may be facilitated via one or more suitable networks 606, such as the Internet, etc.

With continuing reference to FIG. 6, any number of computers 604 may be provided. A computer 604 may include any number of processor-driven devices, including, but not limited to, a server computer, a personal computer, one or more networked computing devices, an application-specific circuit, a minicomputer, a microcontroller, and/or any other processor-based device and/or combination of devices. Directing attention to FIG. 7, computer 602 may utilize one or more processors 612 to execute computer-readable instructions that facilitate the general operation of the computer 602.

In addition to having one or more processors 612, the computer 602 may further include one or more memory devices 614 (generally referred to as memory), one or more input/output (“I/O”) interface(s) 616, and/or one or more communication connections 618. The communication connections 618 may interface with a database 620, which may contain one or more data files, such as 610.

The memory 614 may be any computer-readable medium, coupled to the one or more processors 612, such as random access memory (“RAM”), read-only memory (“ROM”), and/or removable storage devices. The memory 614 may store one or more program modules utilized by the computer 602, such as an operating system (OS) 622. The various components depicted in FIG. 7 may communicate with each other across bus 623.

Certain embodiments may be provided as a computer program product including a non-transitory machine-readable storage medium having stored thereon instructions (in compressed or uncompressed form) that may be used to program a computer (or other electronic device) to perform processes or methods described herein. For example, certain embodiments may be provided as a computer program product or group of products that may be executed by the computers 602 or other suitable computing systems. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, distribution of software may be Internet download.

With reference to the contents of the memory 614, the data files 610 may include any suitable data that facilitates the operation of the computer 602 and/or interaction of the computer 602 with one or more other components of the system 600.

A wide variety of suitable networks, such as 606, (which may be the same or separate networks) and/or communication channels may be utilized to facilitate communications between the client devices 604, the computers 602 and/or other components of the system 600. These networks may include, but are not limited to, one or more telecommunication networks, cellular networks, wide area networks (e.g., the Internet), and/or local area networks. Various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

The system 600 shown in and described with respect to FIG. 6 is provided by way of example only. Numerous other operating environments, system architectures, and device configurations are possible. Other system embodiments can include fewer or greater numbers of components and may incorporate some or all of the functionality described with respect to the system components shown in FIG. 6. Accordingly, embodiments of the disclosure should not be construed as being limited to any particular operating environment, system architecture, or device configuration.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the invention.

Various block and/or flow diagrams of systems, methods, apparatus, and/or computer program products according to example embodiments of the invention are described above. It will be understood that one or more blocks of the block diagrams and flow diagrams, and combinations of blocks in the block diagrams and flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The invention claimed is:

1. A method of reducing risk in trade credit transactions, comprising:
receiving an offer to sell a trade receivable from a business;
obtaining a credit rating for the business;
instructing a sellers cooperative to pay a first portion of a purchase price to the seller, the sellers cooperative comprising small businesses that sell trade receivables to a servicer of trade receivables; and
instructing a lender to release a second portion of the purchase price held in escrow to the seller after a period of time has passed.

2. The method of claim 1, further comprising purchasing a guarantee, the guarantee paying a benefit if the business fails during a period of time.

3. The method of claim 2, wherein the guarantee is issued by a government.

4. The method of claim 1, further comprising receiving payment on the trade receivable from a buyer of goods or services from the seller from which the trade credit was purchased.

5. The method of claim 4, wherein the buyer makes periodic payments on the trade receivable.

6. The method of claim 4, further comprising purchasing an insurance policy, the insurance policy paying a benefit if the buyer fails to pay the trade receivable.

7. The method of claim 1, wherein obtaining a credit rating for the business comprises verifying that the business has no adverse filings against it by a government agency.

8. A method of reducing risk in trade credit transactions, comprising:
receiving an offer to sell a trade receivable from a business;
obtaining a credit rating for the business;
admitting business to a sellers cooperative, the sellers cooperative comprising a plurality of companies selling trade receivables to the servicer;
purchasing a guarantee on the business, the guarantee paying a benefit if the business fails during a period of time after the sale of the trade receivable; instructing a sellers cooperative to pay a first portion of a purchase price for the trade receivable to the business upon purchasing the trade receivable; and
paying a second portion of the purchase price to the business after a period of time has passed.

9. The method of claim 8, wherein the guarantee is purchased from a government issuer of guarantees.

10. The method of claim 8, further comprising paying a third party for inviting the business to sell the trade receivable.

11. The method of claim 8, further comprising receiving payment on the trade receivable from a buyer of goods or services from the business from whom the trade receivable is purchased.

12. The method of claim 11, further comprising purchasing insurance that pays a benefit if the buyer fails to pay for the trade receivable.

13. The method of claim 8, wherein upon purchasing the trade receivable, it is assigned to a cooperative of sellers.

14. The method of claim 13, wherein the business from which the trade receivable is purchased holds equity in the cooperative of sellers until the second portion of the purchase price is paid to the business.

15. A method of reducing risk in trade credit transactions, comprising:
receiving an offer to sell a trade receivable from a business;
obtaining credit rating for the business;
paying a first portion of a purchase price to the business upon purchasing the trade receivable;
assigning the purchased trade receivable to a cooperative of sellers, the cooperative of sellers holding assets including assigned trade receivables; and
issuing equity in the cooperative of sellers to the business.

16. The method of claim 15, wherein the business from which the trade credit is purchased holds equity in the cooperative of sellers until the second portion of the purchase price is paid to the business.

17. The method of claim 15, wherein the credit rating comprises a credit score issued by a Small Business Financial Exchange.

18. The method of claim 15, further comprising purchasing a guarantee, the guarantee paying a benefit if the business fails during a period of time.

19. The method of claim 18, wherein the guarantee is issued by a government.

20. The method of claim 15, further comprising purchasing insurance that pays a benefit if a buyer of goods and services from the business to which the trade receivable is owed fails to make payment on the trade receivable.
